(19) United States
(12) Patent Application Publication
(10) Pub. No.: US 2011/0080262 A1
(43) Pub. Date: Apr. 7, 2011

(54) LOCATION FINDER SYSTEM

(76) Inventors: Mark A. Richardson, Oluthe, KS (US); Kenneth H. Stueve, Edgerton, KS (US)

(21) Appl. No.: 11/913,783

(22) PCT Filed: Aug. 29, 2005
(86) PCT No.: PCT/US05/30702

§ 371 Date: Nov. 7, 2007

Related U.S. Application Data
(60) Provisional application No. 60/687,426, filed on Jun. 3, 2005.

(51) Int. Cl. G08B 5/22

(52) U.S. Cl. 340/8.1

(57) ABSTRACT

A locating system for locating a specific subject among a number of possible subjects having an RFID tag attached to subjects which, when interrogated by an RFID reader, provides a unique identification code. A database containing information about subscribers including a list of RFID tag codes associated with the subjects of interest is included in the system. Transceivers having an RFID reader and a processor responsive to the transceiver and the RFID reader are also included in the locating system for locating a subject of interest. When the transceivers receive RFID code transmitted via the communications network, the transceiver is activated to transmit data to any nearby RFID tags. Upon receipt of a response from the RFID tag, the transceivers transmit the tag data to the communications network so that the subject of interest can be located.

### CROSS-REFERENCE TO RELATED APPLICATION

This application claims the benefit of U. S. provisional application No. 60/687,426 filed Jun. 03, 2005 which is incorporated herein by reference.

### FIELD OF THE INVENTION

The present invention relates to a remote locator system for identifying and locating remote objects through the use of readable identification tags such as radio frequency identification tags located on or around the object to be located.

### BACKGROUND OF THE INVENTION

Children and personal items may be lost on a daily basis. Particularly, the loss of a child is a concern within society, one that may be better avoided with a locator network which could locate the location of a child or other item of interest. Therefore, it would be beneficial to have a child locating system, which allowed the lost child to be located, with the use of remote location devices.

In addition, because time of response is a critical factor with regard to child health and welfare, there may be an impact on the likelihood of locating a missing child where an extended period of time exists between the incident and response. It therefore would be beneficial to have a location finder network which determines the location of a lost item and dispatches emergency personnel to a remote location quickly.

### SUMMARY OF THE INVENTION

The present invention provides a locating system for locating a specific subject among a number of possible subjects where an RFID tag having a unique identification code is attached to subjects and when interrogated by an RFID reader, the RFID tag identifies itself with the unique identification code. A database is provided which contains enrollment information about network subscribers including a list of RFID tag codes associated with the subscribers' subjects of interest, the database being in communication with a communications network. The database also contains information about wireless subscribers having a transceiver with an RFID reader and a processor responsive to the transceiver and the RFID reader. The transceivers receive RFID codes transmitted via the communications network when a registered subject is identified as being of interest and in need of being located, the transceiver being activated to transmit data to any nearby RFID tags. Upon receipt of a response from the RFID tag, the transceivers transmit the tag data to the communications network so that the subject of interest can be located.

### BRIEF DESCRIPTION OF THE DRAWINGS

FIG. 1 is an overview flowchart of the Location Network System and Process.

FIG. 2 is a plan view of the transceiver device including a Location Finder Module for use with the system.

FIG. 2A is a top plan view of the Location Finder Module for use with present invention.

FIG. 2B is a side elevational view of the Location Finder Module for use with the present invention.

FIG. 3 is an alternative configuration of the transceiver mounted in connection with a street sign for use with the system.

FIG. 3A is another alternative configuration of the transceiver mounted in connection with a structure for use with the system.

FIG. 4 is a cross-functional flowchart of the system and process.

FIG. 5 is a continuation of the cross-functional flowchart from circle A in FIG. 4.

FIG. 6 is a functional block diagram of the location finder module.

FIG. 7 is a flow chart of the processor control.

FIG. 8 is a functional block diagram of the location finder module with an interconnected GPS receiver and antenna.

FIG. 9 is a flow chart of the processor control including a GPS receiver.

FIG. 10 is a flow chart of the processor control including a GPS receiver and MODEM interface.

FIG. 11 is a flow chart of the processor control including interrupt requests.

FIG. 12 is a flow chart of the interrupt requests setup procedure.

FIG. 13 is a flow chart of the processor control including interrupt requests and a GPS receiver.

FIG. 14 is a flow chart of the interrupt requests setup procedure including a GPS interrupt request.

FIG. 15 is a flow chart of the processor control in communication with a GPS receiver.

FIG. 16 is a flow chart of the interrupt requests setup procedure including a GPS interrupt requests.

FIG. 17 is an exemplary Subscriber Safety Information graphical user interface screen.

FIG. 18 is an exemplary Subscription Billing Information Screen for displaying subscriber information.

FIG. 19 is an exemplary table showing various date fields.

FIG. 20 is an exemplary History of Emergency Response report.

### DETAILED DESCRIPTION

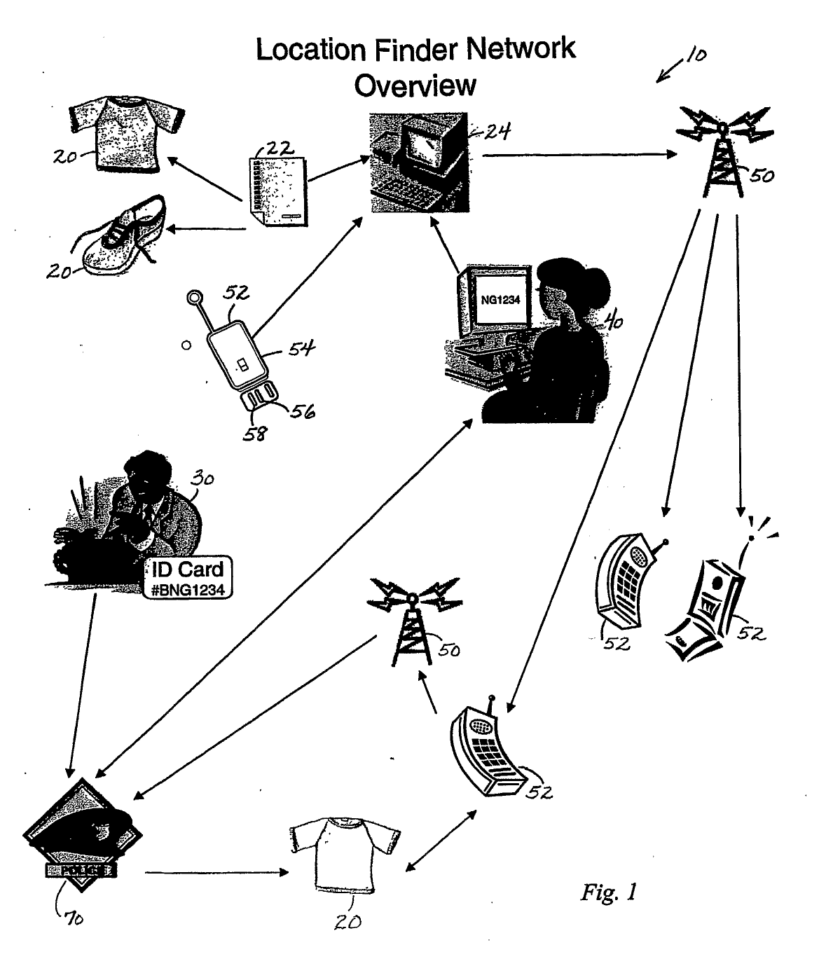

Referring to FIG. 1, a child locator network according to the present invention is generally identified by the numeral 10 and includes a subject or item of interest 20, a parent or interested party 30, a locator administrator 40 for configuring and maintaining the locator network 10, a communications network 50 for wirelessly receiving and transmitting locator information, an interrogation device 52 which interrogates and provides information about the item of interest 20 and a responding party 70 for responding to an identified location to retrieve the child, item or other subject of interest 20.

More particularly, a unique identifying RFID tag 22 is attached to the item of interest 20. The identifying tag 22 has unique information associated therewith, which is recorded or registered by the locator network 10 and electronically stored within a retrievable database 24. The database 24 also contains information about a network subscriber 12 (not shown). Subscribers 12 may be interested parties 30 which can be the parent of a child or any other party with an interest in the item 20. In addition, the subscriber 12 may be a wireless subscriber which is associated with an interrogating device 52. Current subscribers 12 who are enrolled can utilize the network 10 for locating an item of interest 20 which is registered with the network 10. The locator network 10 can receive information and various requests such as an enrollment request to enroll a subscriber 12, a register request to register an item of interest 20, a locator request to locate an item of interest 20 and a non-locator request to indicate that an item 20 is no longer missing.

Interrogating devices 52 may have different physical properties; however, in general they include a transceiver 54 equipped with an RFID reader 58 and an associated processor 56 which responds to the RFID reader 58 and the transceiver 54. The RFID reader 58 works in conjunction with the RFID tag 22 which may include but is not limited to passive UHF tags which respond to readers 58 operating in the 860 MHz-930 MHz frequency range for allowing the RFID tag 22 and reader 58 to communicate with each other at a range of between 2 meters and 10 meters.

As shown in FIG. 1, when an interested party 30 places a request to a responding party 70, the responding party 70 contacts the locator network administrator 40, who may access the retrievable database 24 for verification of enrollment of the interested party 30 and to supply any required information to the locator network 10 for communicating the interested party's 30 request to the locator network 10. If required, the locator network 10 then transmits information over the communications network 50 to the transceiver 54 of any enrolled interrogating devices 52. The communications network, which may include but is not limited to a telecommunications network or a TCP/IP network, assists in the transmission or receipt of data between the locator network and the transceiver. In addition, the transmission of data to the transceiver 54 may occur through background processes and may occur without the attention or intervention of the subscriber 12. The information transmitted over the locator network 10 may include but is not limited to code or information related to the RFID tag 22. Upon receipt of RFID tag data supplied by the locator network 10 via the communications network, the transmit mode of the transceiver 54 is activated. The activation of the transceiver enables the RFID reader 58.

While in transmit mode the transceiver 54, through the RFID reader 58, interrogates any in-range RFID tags 22 by transmitting a packet of data containing tag specific information. Upon interrogation, any responsive RFID tags 22 supply RFID tag data to the RFID reader 58. The identity of the tag 22 is compared by the processor 56 with the tag identification data supplied by the locator network 10. When the identity of the responsive tag 22 is compared to and matches the locator network supplied tag identity, the processor 56 supplies the tag identification information along with any tag data supplied by the RFID reader 58, to the locator network 10. Known protocols of communication between RFID readers and RFD tags which allow for the transmission of the tag data from the tag to the reader may include but is not limited to the EPC Class 1, 96-bit data standard.

Upon receipt of tag data which matches the tag identification data supplied by the locator network, the transceiver 54 transmits the responsive tag data to the locator network 10 via the communications network 50. In addition, the transceiver 54 may supply additional information to the locator network 10. Additional information may include location specific information such as but not limited to GPS longitudinal and latitudinal coordinates provided by a position determining system. In this manner the location of the item of interest 20 can be determined. Alternatively, the network 10 may utilize 911 or E911 technologies to determine the approximate location of the responsive RFID tag. Upon receipt of this information, the locator network 10 determines the identity and location of the item of interest 20. The locator network may then forward or otherwise make the RFID tag information and location specific information available to the responding party 70. The responding party 70 may then decide how to proceed based upon the transmitted information. If necessary, the responding party 70 may decide to conduct a field investigation including the use of an aircraft with a high powered RFID reader, to obtain additional information regarding the responsive tag 22 or the responding party 70 may simply contact the interested party 30 and supply the tag and location specific information. Once the responding party 70 has received the responsive tag data, the locator administrator 40 would be contacted and the locator network 10 would evaluate the current status condition and make a determination regarding whether any additional information should be transmitted to the transceiver 54 or whether to return the locator network 10 to a non-active condition.

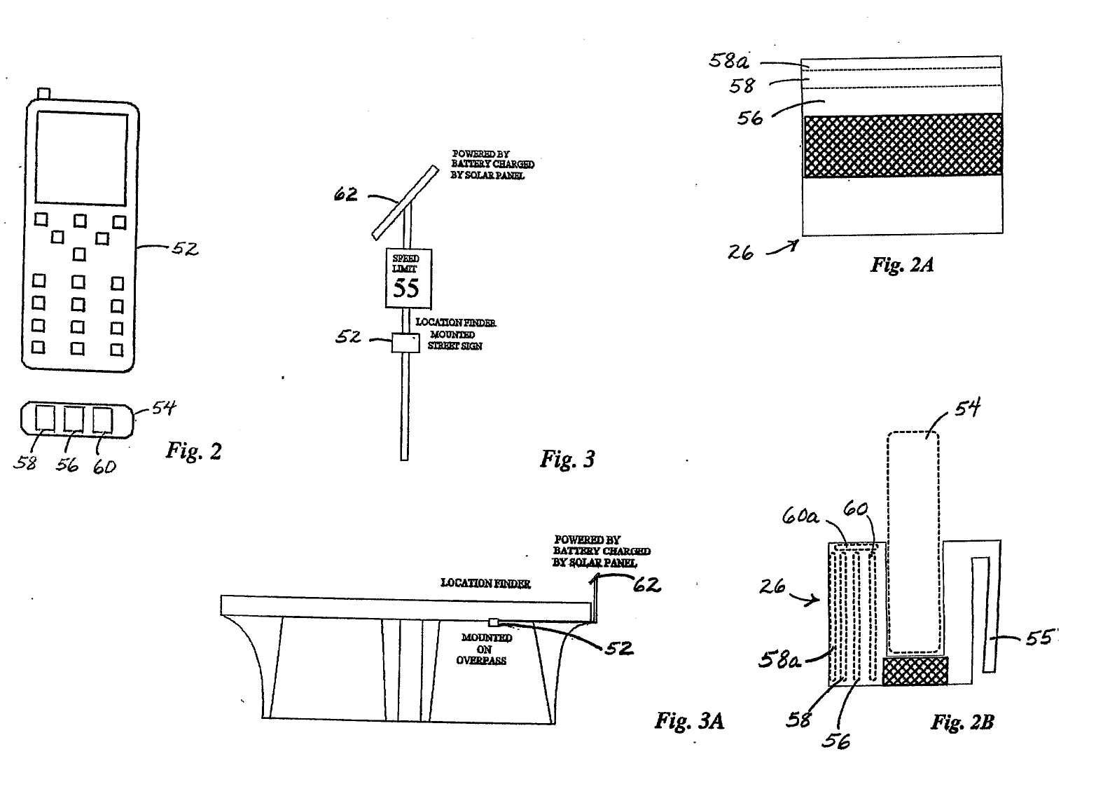

FIG. 2 illustrates a typical arrangement of the handheld interrogation device 52 in which the transceiver 54, RFID reader 58 and a position determining system 60 are internally located. Alternatively, the transceiver 54, RFID reader 58 and processor 56 may be adjacently mounted in a separate locator module 26. The separate locator module 26, may be fabricated from a plastic material arranged with the RFID reader 58 and associated antenna 58a mounted internally within the locator module 26 having a cradle for receiving the transceiver 54 illustrated in FIGS. 2A and 2B. In addition, a belt clip or holster 55 may be added to the rear of the locator module 26 as illustrated in FIG. 2B for the convenience of the wearer and to secure the module 26 along the wearer's waist (not shown). The locator module 26 may also include a position determining system 60 with an associated antenna 60a. Communications between the RFID reader 58 within the locator module 26 and the transceiver 54 may utilize wired connections or wireless connections such as but not limited to BLUETOOTH technologies in which the processor 56 is operative with a program stored in a memory for establishing a wireless communication interface between the processor 56 and the RFID reader 58 and/or the transceiver 54 for transmitting information between the RFID reader 58 and the transceiver 54.

An example of a well known position determining system 60 includes a GPS receiver and antenna which are commercially available within mobile phones as are RFID readers. Alternatively, to provide location specific information to the transceiver 54 the interrogation device 52 may utilize current E911 technologies to provide location specific information to the locator network 10. To help reduce interference, radio-frequency shielding may be strategically located between the various antennas within the handheld unit to prevent any unwanted interference between the various device components within the transceiver 54.

Alternative mounting arrangements are illustrated in FIGS. 3 and 3A. FIG. 3 illustrates the interrogation device 52 contained within a weather resistant protective enclosure mounted at a roadside location on a roadside sign with the transceiver and a RFID reader operatively connected therein. The interrogation device 52 is shown receiving power through solar panel 62. Alternatively, the solar panel 62 may provide power to the RFID reader or both. FIG. 3A illustrates the interrogation device 52 mounted along the underside of a structure, again the interrogation device being powered by an external solar panel 62. A series of fixed-mounted enclosures located along plural roadside locations may be utilized by the locator network for locating the subject of interest.

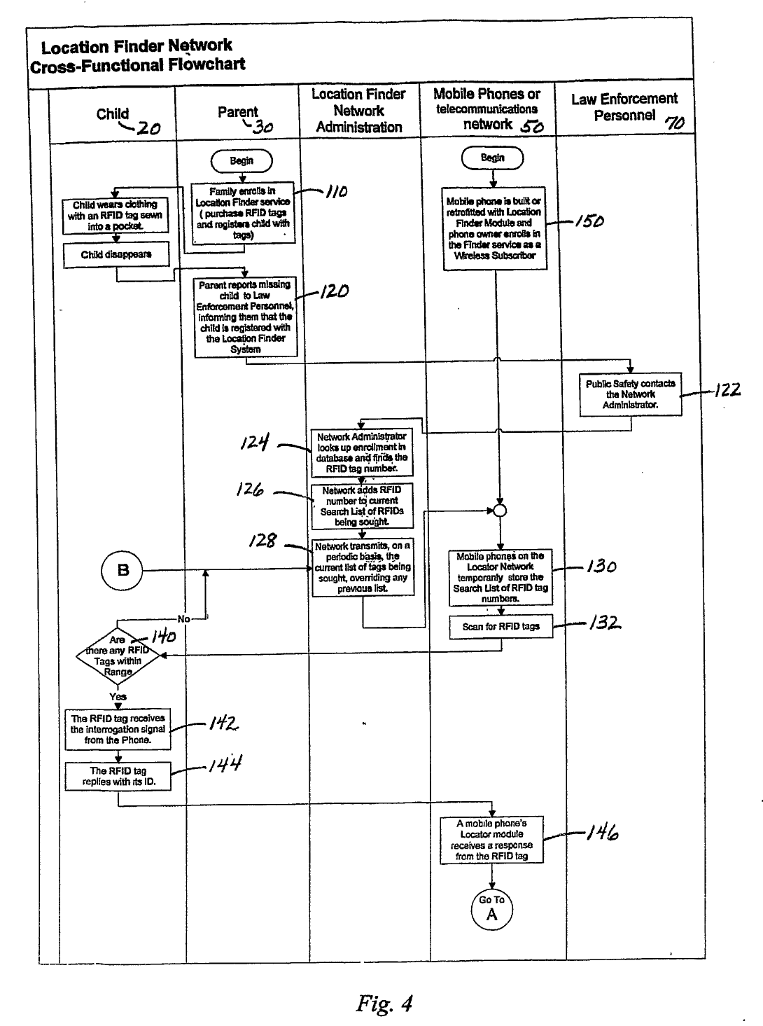

In FIG. 4, an embodiment is shown with the item of interest 20 being illustrated as a child, the interested party 30 being illustrated as a family or a parent, the transceiver 54, interrogation device 52, processor 56 with storage capacity and RFID reader 58 being collectively illustrated as a mobile phone such as a cell phone communicating over a communications network 50, while the responding party 70 is identified as a law enforcement personnel.

Subscribers to the network may join as either an interested party 30 or as a wireless subscriber in possession of the interrogating device 52 such as but not limited to a handheld mobile phone 50. The mobile phone 50 includes the RFID reader 58, transceiver 54 and the processor 56 within the Location Finder Module 150 either furnished as a retrofit or built-in using current mobile phone technologies. If multiple wireless subscribers obtain the interrogation device 52 and are enrolled in the network 10, an association of remote interrogating devices 52 is created for identifying items of interest 20, such as children. Alternatively, the interested party, such as a family member or parent may enroll in the network and register their child or another item of interest by purchasing an RFID embedded item or tag and subscribing to the Location Finder Service. During enrollment, the parent may provide RFID tag information to the locator network for recording and retrievably storing within the database. Alternatively, the information may be provided to the network by a merchant who provides the RFID tag device either manually by the merchant or automatically with a point of sale device.

In the event a child disappears 120 the parent may contact the local law enforcement personnel, informing them that the missing child is registered with the locator network. Law enforcement may then contact 122 the Locator Network Administrator who retrieves the stored information 124 related to the missing child such as family information or id of the tags associated with the child. Tag data is added to the current list of pursued tags 126, if any, and then transmitted 128 via the telecommunications network to the wireless subscriber's mobile phone. Once received, the list of pursued tags is temporarily stored 130 within the phones' memory and the associated RFID reader begins to search for any responsive RFID tags 132.

If any tags are within the range 140 of the RFID reader, the tag will receive an interrogation signal 142 from the mobile phone's associated RFID reader and respond 144 with the tag identity. The tag identification is received by and processed 146 within the Locator module connected to the phone. If no tags are responsive or within the range of the RFID reader, the reader continues to scan for tags. Periodically, the locator network transmits the current list of pursued tags through the telecommunications network to be stored within the mobile phone, in effect overriding any residing tag ids stored within the phone's memory.

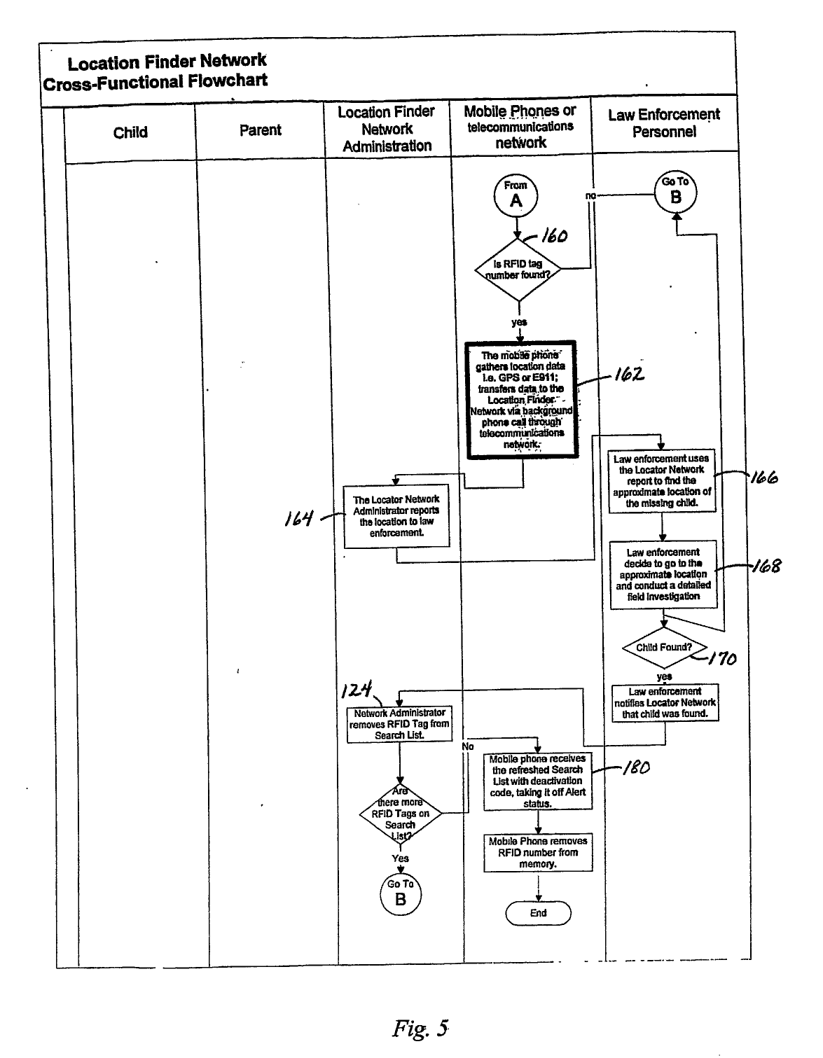

The locator module compares the responsive tag identification with the stored tag information to determine if a match exists, as shown in reference number 160 in FIG. 5. If they do not match, the reader continues to scan for any responsive tags using standard protocols, such as but not limited to the EPC Class 1 protocol. If the tag identification matches the stored tag information, the mobile phone accumulates location specific data 162, such as GPS provided longitudinal and latitudinal coordinates, and transfers this information along with the responsive tag information to the locator network through the telecommunications network. The locator network then transmits the gathered data 164 to the law enforcement personnel who then use the information 166 to determine the approximate location of the missing child. Law enforcement personnel may then decide to conduct a field investigation with more powerful or accurate RFD readers 168 to determine the location of the child. If the child is found 170, the locator network is notified 174 and the network administrator removes the RFID tag identifier from the list of pursued tags. Otherwise, the network continues to search for RFID tags as periodically updated by the locator network as shown in FIG. 4. When no more tags are being pursued, the locator network will send out a deactivation code 180, removing the current list of pursued RFD tags from the reader's memory.

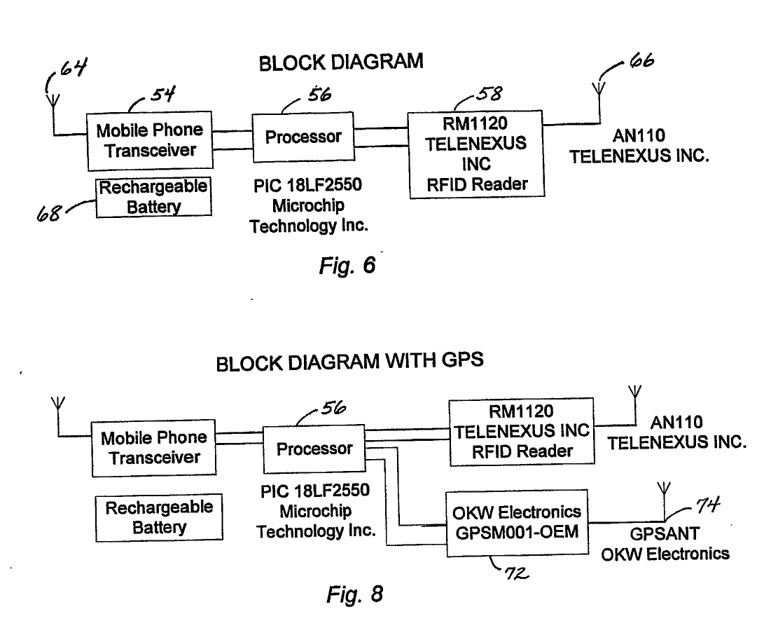

FIG. 6 shows the transceiver of the mobile phone 54 communicating with the processor 56 which is in communication with the RFID reader 58. The mobile phone transceiver 54 also includes an antenna 64 allowing the device to communicate with the communications network 50. In addition, the RFD reader 58 includes an RFID antenna 66 which allows the reader 58 to communicate with any nearby RFID tags 22, the reader 58, the mobile phone 54 and processor 56 being powered by a rechargeable battery 68. To help conserve power and thus the need to recharge the battery 68, the transceiver 54 may cycle between an energized to an un-energized condition, depending on the model of transceiver, during periods of inactivity. Alternatively, the RFID reader 58 can be optionally powered down thereby reducing the power demand of the transceiver 54 and the need to recharge the battery 68.

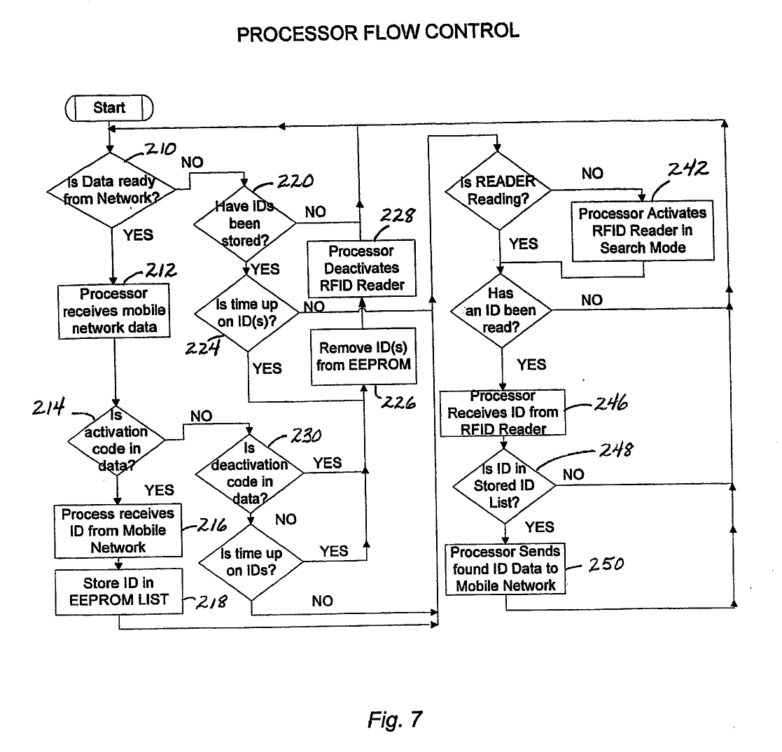

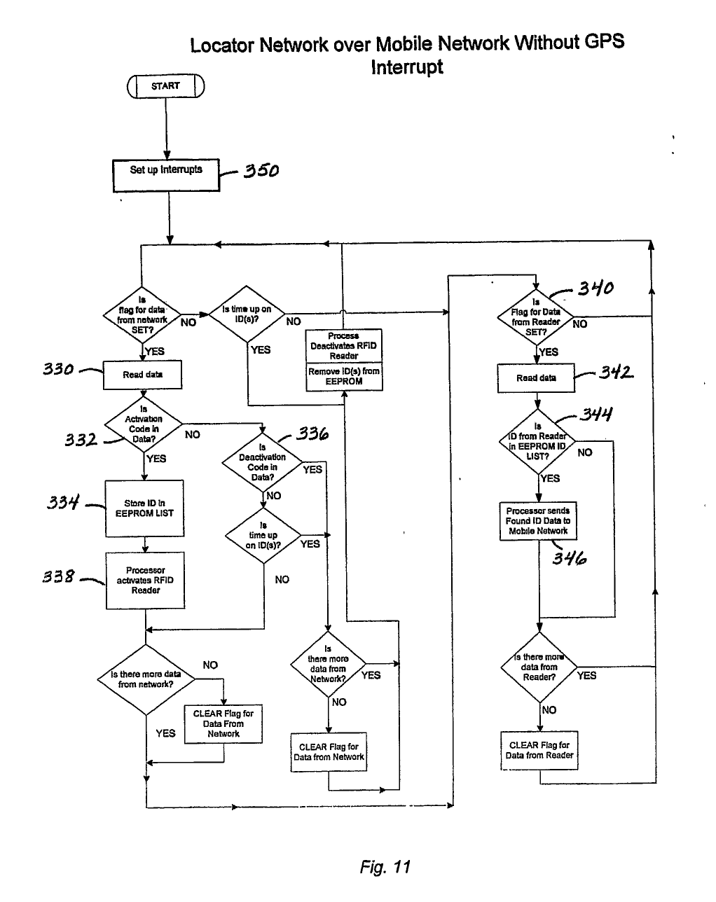

FIGS. 7, 9 and 10 are illustrative drawings which show various sequential flow charts for the locator module 26. It will be appreciated, however, that one skilled in the art will appreciate that the various routines can be preformed concurrently, separately or in different orders including with the use of interrupt requests as illustrated in FIGS. 11-16.

Processors like the PIC 18LF2550 microchip available from Microchip Technology, Inc. are known and may include memories for storing programs or routines for controlling the processor. When a processor receives information or data, the program may determine what and how the processor will respond. As shown in FIG. 7, when tag data is available and ready 210 from the locator network, the processor receives the data 212 and determines whether or not to activate the RFID reader based upon the presence of an activation code contained within the received data 214. If activated, the processor receives RFID data 216 from the mobile network and stores the current list of pursued RFID tags 218, with the associated RFID data, within the memory of the processor which may be but is not limited to an EEPROM technology internally integrated within the processor. If the RFID reader is not active, the processor activates the reader and places it in a search mode 242 where the reader scans for any in-range RFID tags. If the reader is already active and in search mode the processor determines if the reader has any RFID tag data for receipt by the processor 246. Alternatively, the locator network may simply periodically update the transceiver with the current list of pursued RFID tags overwriting any previous RFID tag data. If tag data is available from the reader, the processor receives the tag data and determines the tag identification for comparison 248 with the tag IDs stored within the processor's memory. If a match exists between the pursued tag identification and the found tag information, the processor transmits 250 the found tag information to the communication network. If no tag data is available or there is no match between the found tag information and the pursued tag, the reader continues to scan for available RFID tags while the processor determines if the network data is available.

When the processor receives network data which contains a deactivation code 230, the tag ID's are removed from the processor's memory 226 and the RFID reader is deactivated 228. The processor then continues to scan for instructions or information from the locator network. Without a deactivation command, after a period of time 224 the stored RFID data will be removed from the processor memory 228 and the reader will be deactivated 226.

Although, the location network can work with a number of position determining technologies which are known in the art, including but not limited to GPS, E911 and various telecommunication triangulation methods, the block diagram illustrated in FIG. 8 provides location information to the locator network 10 with the use of a GPS receiver module 72 and antenna 74 operatively connected. In addition to the details described previously in FIG. 6, the GPS 72 receiver is in communication with the GPS antenna 74 and the processor 56 to provide location specific information, including longitude and latitudinal information to the processor 56. The position determining device may be externally located with respect to the transceiver or optionally, the position determining device may be integrated with the transceiver and located within a common structure like an enclosed container.

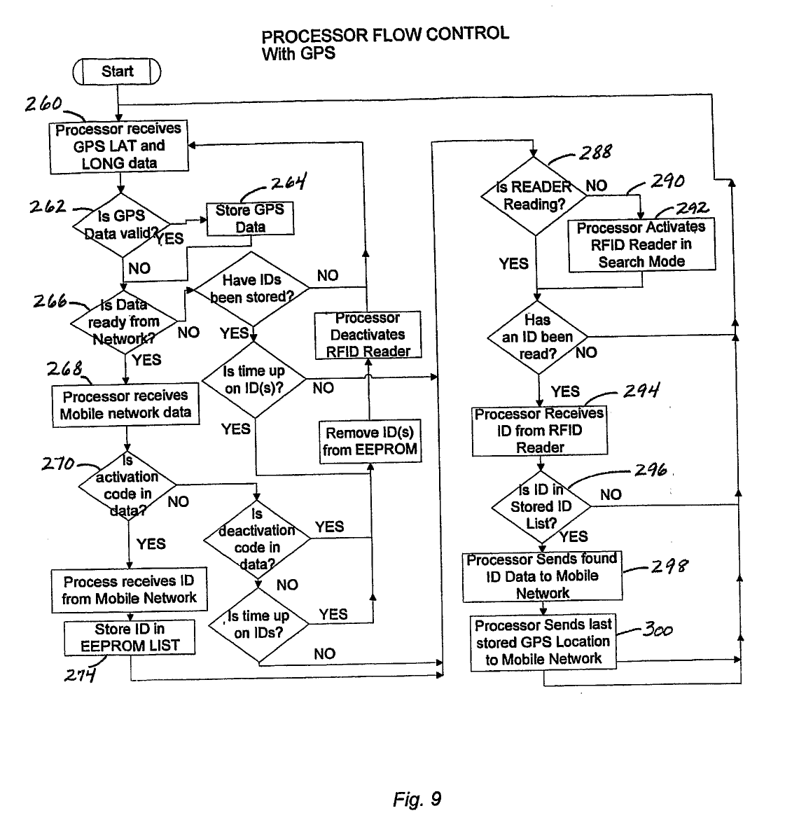

The instruction flow chart of the processor which includes a GPS receiver for providing location specific information is illustrated in FIG. 9. Upon receipt of GPS data 260, the processor verifies the data 262 and if valid, the location data is stored 264 by the processor. As described above, after the network transmits RFD data to the processor, including the activation command, the data is retrievably stored 274 for comparison with the data received 294 by the RFID reader. When the processor receives RFID tag data which corresponds to tag data stored within the processor's memory 274, the processor transmits 298 the RFID data to the locator network via the telecommunication network along with the most recent stored GPS location data 300 for identifying the approximate location of the responsive tag. In this way the network is able to provide location data to the responding party.

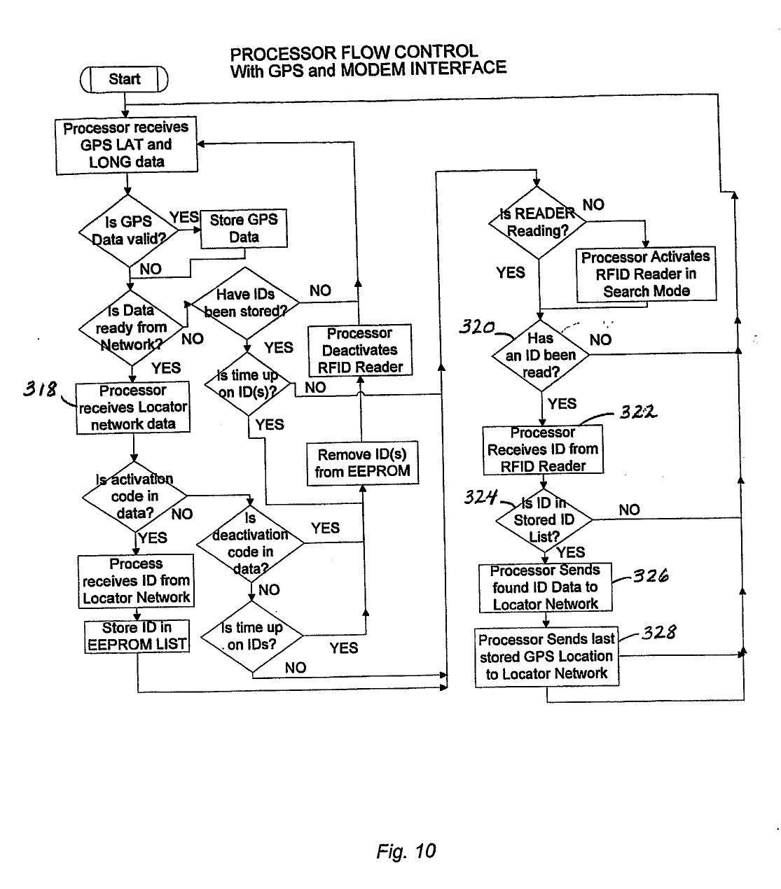

The locator module 26 illustrated in FIGS. 2A and 2B may also be utilized as a retrofit for older analog based cell phones as indicated in FIG. 10. In addition, the locator module 26 may be designed for a device without a connection to the telecommunications network by providing, for example, a modulating and demodulating (MODEM) device (not shown) within the locator module 26 for operatively connecting the transceiver 54 to the locator network 10. The operative connection between the modem device and the transceiver 54 provide an alternative communications path for use by the locator network 10. FIG. 10 illustrates such an arrangement with the processor receiving data 318 from the locator network through the locator module with the built in MODEM device. When a responsive RFID tag is located 320, the processor transmits 326 the received 322, matching 324 tag data along with the location information 328 to the locator network through the MODEM device. In this way, the locator network can interface directly with the law enforcement personnel and provide tag and location information regarding the responsive tag for a possible field investigation.

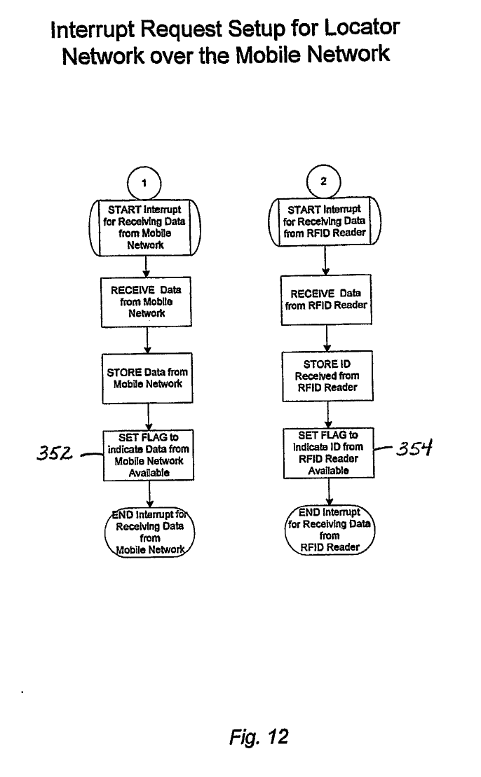

FIG. 11 is an illustration of the locator network using interrupt requests for facilitating control of the system. Two different interrupt request setup procedures are shown in FIG. 12 each of which provide an interrupt request to be issued to the processor. The first interrupt request 352 is provided to indicate that data is available, for example, when data is received and stored from the telecommunications network. The interrupt request 352 is provided to indicate network data is available. Also, an interrupt request 354 is provided when data is received and stored from the RFID reader, to indicate the RFID reader data is available. Depending on the status of each of these interrupt requests, which are issued to the processor, the control as depicted in FIG. 11 is altered. When the interrupt request 352 indicating data is available from the telecommunications network is issued to the processor, the processor will read 330 the network data. The processor also determines if an activation code is present within the data 332. If so, the locator network stores the data 334. Unless there is additional data which is available from the locator network, the flag indicating data is available from the locator network, is cleared. Similarly when a deactivation code is transmitted 336 by the locator network, the system reads the data and unless additional data is available from the network, the system data flag is cleared.

In addition, when network data is stored, the processor activates 338 the RFID reader. When the interrupt request 354 is issued to indicate data is available from the RFID reader, the processor reads the reader data 342 and compares it with the data in the processor's memory. If the data matches 344, the processor sends the found id data 346 to the network. In addition when the RFID reader has been read the RFID reader data flag is cleared unless there is additional data available from the reader.

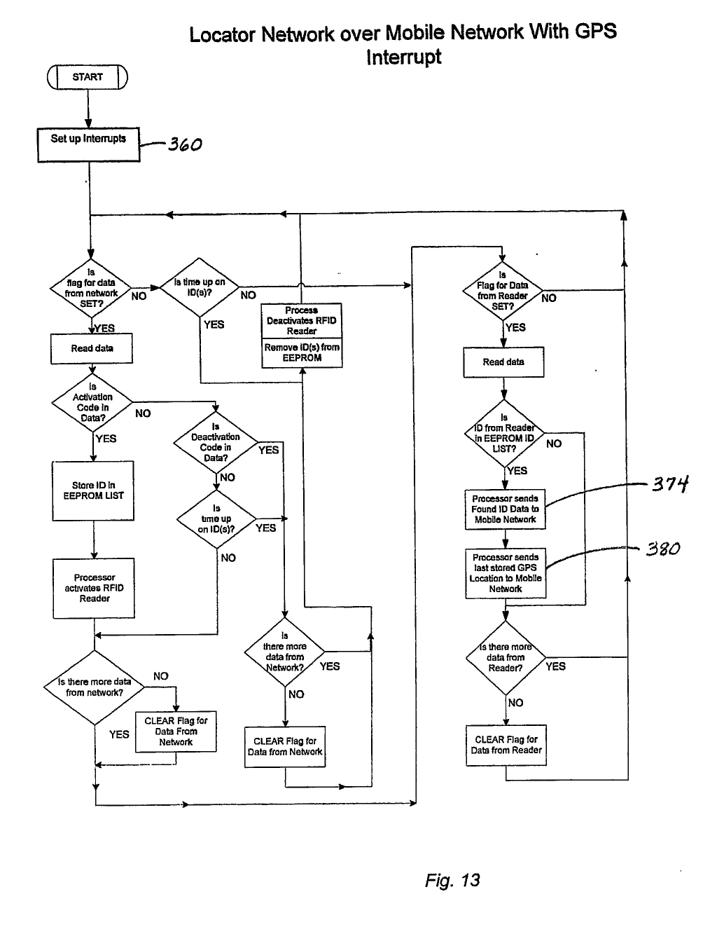

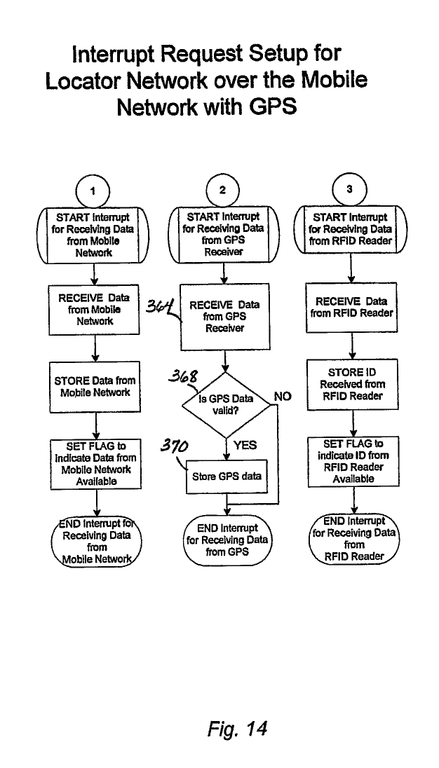

FIG. 13 is an illustration of the locator network utilizing GPS technology controlling the network using interrupt requests. Three different interrupt request setup procedures are shown in FIG. 14, similar to FIG. 12 except for the inclusion of an interrupt request setup procedure for issuing an interrupt request to the processor for storing data from the GPS receiver. If GPS data is received 364 and valid 368 then the GPS data will be stored 370. When the processor sends found RFID data 374 to the network, stored GPS location data is also transmitted 380 to the network.

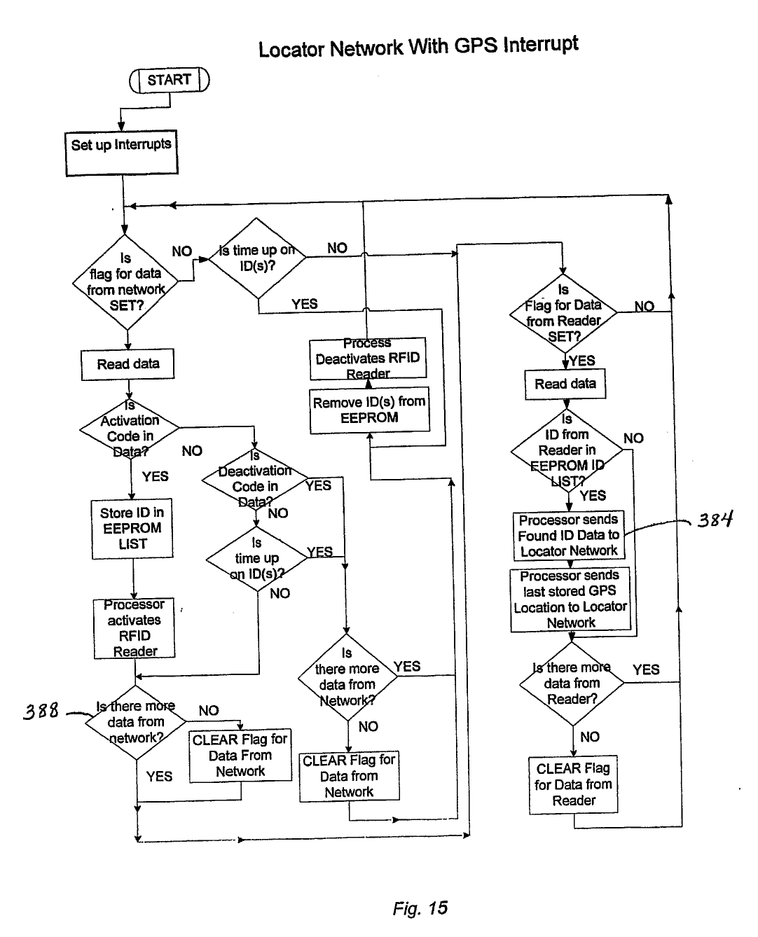

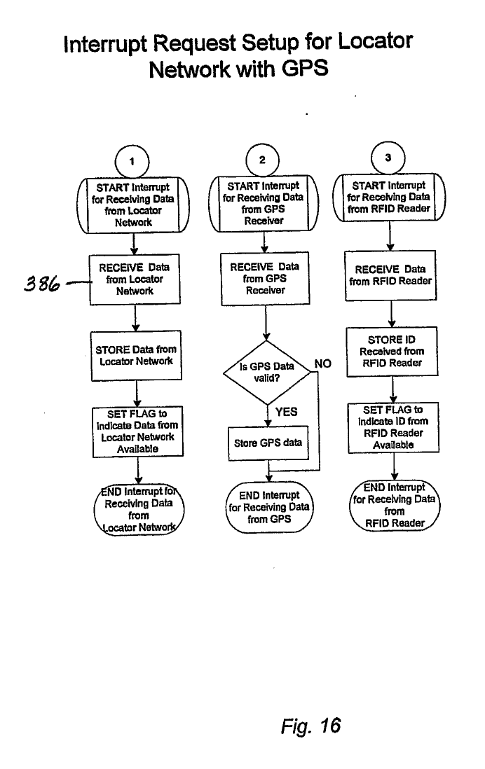

FIG. 15 is an illustration of the locator network utilizing GPS technology for providing location information which is sent to the locator network 384 with the use of a modulating and demodulating (MODEM) device. Three different interrupt request setup procedures are shown in FIG. 16, similar to FIG. 14 except that the network data is transmitted directly to the transceiver from the locator network 386. Likewise, in FIG. 15, data is transmitted to the transceiver from the locator network 388 and information is transmitted from the processor to the locator network directly 384.

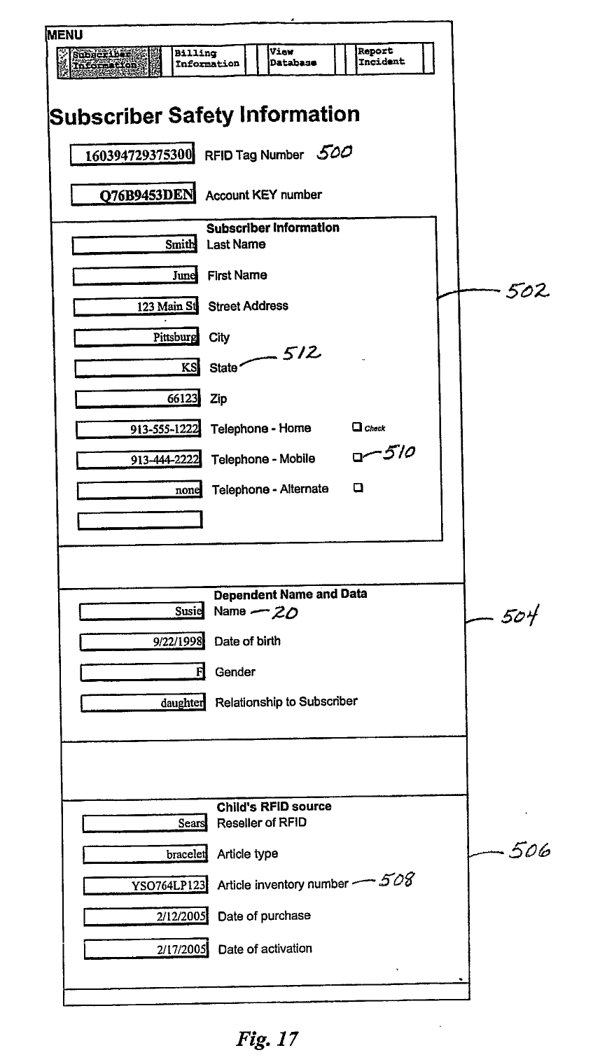

Illustrative graphical user interface display screens from the locator network system are depicted in FIGS. 17-20. It may be appreciated by those skilled in the art that the network 10 may be operated under pre-defined standard or user specified circumstances, such as to alert emergency personnel of a lost child, as in a kidnapping, or to cause the remote devices to stop searching as in the case of a found child. In addition, different data may be obtained to enhance the system functionality or to increase the efficiency of the system, including organizing the system based upon geographic conditions. As shown in FIG. 17, once the subscriber information 502, child specific data 504 and RFID tag information 506 are entered into the locator system via the graphical user interface screen, the child associated with the RFID tag may conduct their normal daily activities without interference from the RFID tag or locator network. Once enrolled, other than a possible billing statement, subscribers may never be aware of their enrollment in the network. However, when a child who is enrolled in the network disappears, the parent or other interested party may contact the emergency personnel to identify the child as being of interest or in need of assistance.

FIG. 17 illustrates an enrollment screen where a subscriber may enroll in the network, provide subscriber information 502 which helps the network administrator store and recall specific child 504 and tag 506 information. The graphical user interface screens, with optionally navigational features, are adapted for display by a display device connected to a computer and for input of data either using manual or automated procedures and can be used by a network administrator or law enforcement personnel to operate the locator network and locate the subject of interest. To allow for manual input procedures, the computer is adapted for the input of data. The graphical user interface screens also display the working status of the locator network, allowing the retrieval of RFID tag codes in response to the data entered within the graphical user interface screens. For example, once enrolled, the child can be identified with one or multiple RFID tag inventory numbers 508. If lost, this information can be transmitted to a plurality of remote interrogatory devices identified within the relational database as wireless subscribers. The wireless subscribers can be identified by their mobile phone number 510 or by their geographic region 512 or both. Once the child is identified as being of interest, the locator network transmits the RFID tag list to the remote devices via the telecommunications network or the locator network for storage within the processor of the remote device. The locator network may be operated or administered remotely by a computer operably connected to the locator network using for example, but not limited to, a LAN, WAN, wireless, HTTP protocol or internet based network.

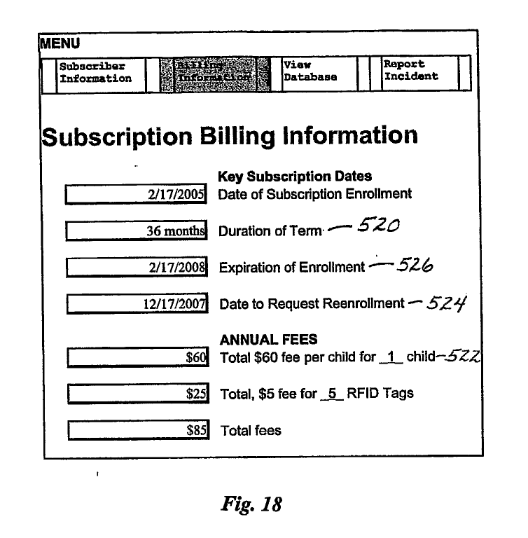

In addition to entering specific information about the item of interest 504, the system also maintains subscriber information as shown in FIGS. 17 and 18, including the terms of the subscription 520, the fee charged 522, the date for reenrollment 524 and the expiration of the enrollment period 526. Using this information the locator system maintains information about each subscriber and is able to automatically generate re-enrollment requests or confirm subscriber status.

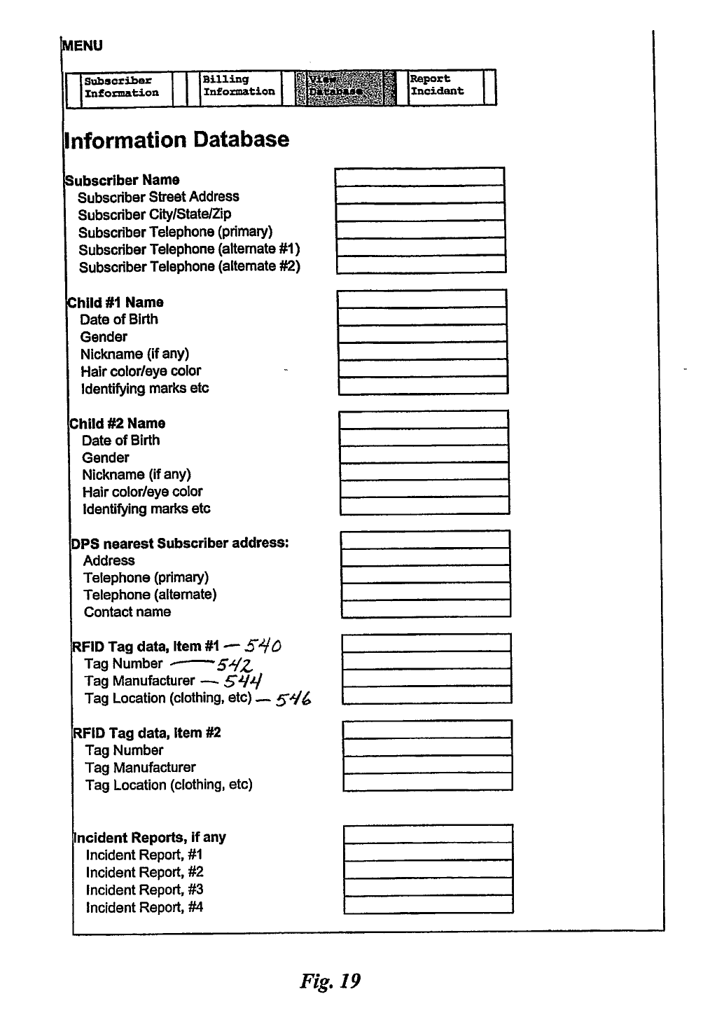

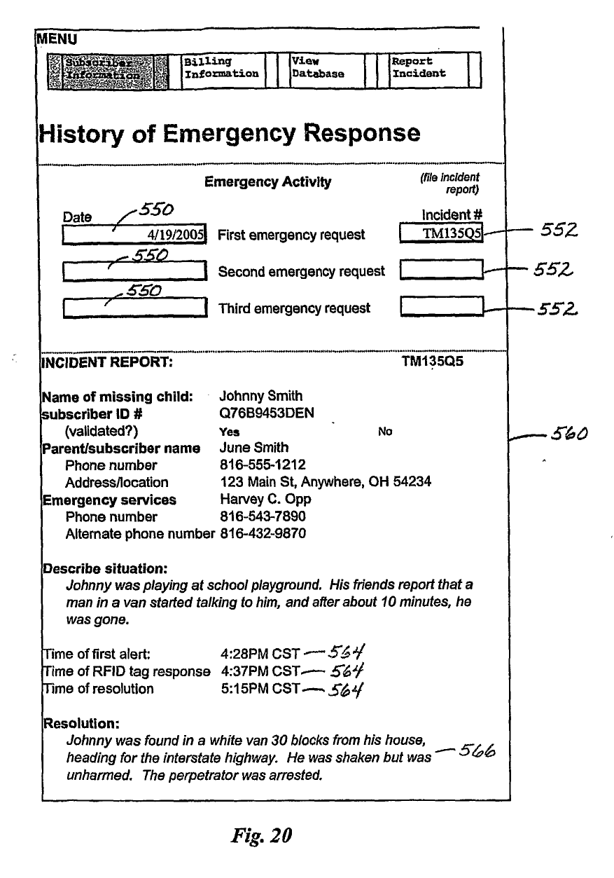

The information collected by the system is stored in a relational table or database, an example of which is illustrated in FIG. 19. Because each subscriber can have multiple interrogation devices, multiple children, and multiple tags associated with each child, the database allows the system to efficiently retrieve the various data for utilization by the network. Each RFD tag 540 contains information related to the tag number 542, the tag manufacturer 544 and the item associated with each tag 546. In addition, the network can generate reports for use by the system, including financial reports, maintenance reports and account activity. An example of a historical report is illustrated in FIG. 20 where the emergency response activity is illustrated indicated the date of requests 550, the associated incident numbers 552 and the incident summary information 560 including time of activity 564 and resolution 566 of the incident.

1. A method of locating a subject of interest among a number of subjects, said method comprising the steps of:
(a) attaching RFID tags to the respective subjects, each of said tags having an unique RFID code that is transmitted therefrom upon receiving an RF interrogation signal,
(b) providing a database of said RFID tag codes for a wireless communications network having subscribers enrolled in a finder network,
(c) equipping a transceiver used by each of said subscribers with an RFID reader and an associated processor responsive to the transceiver and reader,
(d) transmitting the associated RFID code via the communications network to the transceivers in response to a report that the subject of interest is to be located,
(e) at each of the transceivers receiving the RFID code from the communications network, activating the transceiver to a transmit mode that produces the interrogation signal, thereby interrogating any RFID tags within range, and
(f) at each transceiver that receives a reply, transmitting data therefrom to the communications network that identifies the transceiver and the found RFID code, whereby the subject of interest can be located.

2. The method as set forth in claim 1 wherein:
said communications network is a telecommunications network, and
said transceiver includes a wireless mobile phone in communication with the telecommunications network for locating the subject of interest.

3. The method of claim 1 wherein the subscriber is enrolled in the finder network by a merchant having a point of sale device.

4. The method as set forth in claim 1 wherein said step (c) further includes the step of furnishing the transceiver with a locator module having the RFID reader and processor responsive to the transceiver and reader integrally located therein.

5. The method as set forth in claim 4 further comprising the additional step of carrying the transceiver and the locator module with a belt clip located on the rear of the locator module.

6. The method as set forth in claim 4 further comprising the step of storing a program for controlling the processor in a memory, the processor being operative with the program for establishing a wireless communication interface to the reader.

7. The method as set forth in claim 4 further comprising the step of storing a program for controlling the processor in a memory, the processor being operative with the program for establishing a wireless communication interface to the transceiver.

8. The method as set forth in claim 1 wherein said step (c) further comprising the additional step of installing a series of mounted protective enclosures at respected roadside locations, each having the transceiver and RFID reader operatively connected therein.

9. The method as set forth in step (c) of claim 1 further comprising the step of cycling the transceiver during an inactive period between an energized condition and an un-energized condition for conserving power.

10. The method as set forth in claim 1 further comprising the steps of:
transmitting locator network data with a modem associated with the locator network, and
receiving the locator network data by a modem associated with the transceiver for operatively connecting the transceiver to the locator network for locating the subject of interest.

11. The method as set forth in claim 1 further comprising the step of providing an interrupt to the processor for controlling the processor response.

12. The method as set forth in claim 1 further comprising the step of determining a geographic location of at least one of the transceivers using a position determining system in communication therewith.

13. The method as set forth in claim 12 wherein the geographic location is determined by the position determining system located within a structure associated with the transceiver.

14. The method as set forth in claim 12 wherein the position determining system determines the geographic location with a global positioning system having an antenna operatively connected to a receiver module.

15. The method according to claim 1 wherein the finder network periodically updates the transceivers with a list of RFID tag data.

16. The method according to claim 1 further comprising the steps of:
operating the locator network by utilizing a graphical user interface adapted for the input of data to a computer having an input device,
displaying the operative status of the locator network on a display device connected to the computer, and
retrieving RFID tag codes in response to the input of data on the displayed graphical user interface.

17. The method as set forth in claim 16 wherein the steps of operating, displaying and retrieving are performed on the computer at a location remote from the locator network, the computer operably connected to the locator network over an internet connection.

18. The method as set forth in claim 1 further comprising the step of generating reports for use by the locator system.

19. A locator system for determining the geographic location of a subject of interest among a number of subjects said system comprising:
a plurality of RFID tags each of which are adapted for attaching to a subject of interest,
an electronic storage media for retrievably storing RFID tag data associated with the RFID tags,
an interrogation device for producing an interrogation signal,
said RFID tags being responsive to said transmitted interrogation signal whereby the RFID tag data is transmitted in response to said interrogation signal, and
a network of transceivers responsive to a communication network, each of the transceivers having an RFID reader and a processor responsive to the transceiver and reader, wherein said transceiver transmits data to the locator system upon identification of the RFID tag attached to the subject of interest.

20. The system as set forth in claim 19 wherein said interrogation device is a mobile phone equipped with an RFID reader and an associated processor responsive to the transceiver and reader.

21. The system as set forth in claim 19 further comprising a position determining system for determining the geographic location associated with at least certain of the transceivers.

22. The system as set forth in claim 19 further comprising a plurality of graphical user interface screens displayed on a display device adapted for the retrievable storage of the RFID tag data associated with the subject of interest for use by the locator system.

23. The locator system according to claim 19 wherein the transceiver is a geographic transceiver for supplying a geographic location associated with the transmitting transceiver.
